(19) United States
(12) Patent Application Publication
(10) Pub. No.: US 2007/0085231 A1
(43) Pub. Date: Apr. 19, 2007

(54) Method for producing microporous plastic products and the plastic products obtainable according to this method, as well as a plastic source material

(76) Inventors: Georg Menges, Aachen (DE); Bernhard Wolf, Bad Soden-Salmunster (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/495,169

(22) Filed: Jul. 27, 2006

Related U.S. Application Data
(63) Continuation of application No. PCT/DE05/00100, filed on Jan. 25, 2005.

(30) Foreign Application Priority Data
Jan. 27, 2004 (DE) 102004004237.3-43

(51) Int. Cl. B29C 44/00

(52) U.S. Cl. 264/51

(57) ABSTRACT

The invention relates to a method for producing a microporous plastic product using a plastic source material, a physical and/or chemical propellant and further using especially exfoliated nanoparticles. The plastic source material is treated with the propellant in a preceding process steps in the presence of nanoparticles, thereby producing microporous foamed molded plastic articles having a large number of pores and an even pore distribution. The inventive plastic molded articles are not subject to shrinkage or warpage and have an optically appealing, smooth surface as well as advantageous shock and sound absorption properties. The invention also relates to plastic source materials that contain nanoparticles and propellants.

### DESCRIPTION

The present invention relates to a method for producing microporous plastic products, as well as the molded parts, profiles and granulates obtainable with this method, and a plastic source material.

The use of plastic parts in automobiles is increasing constantly. Plastic parts are being used at an increasing rate, particularly in the interior and the body, and in many cases are replacing significantly heavier materials. Plastic parts reduce the total weight of vehicles, are corrosion-resistant, and in most cases are also easy to process. Numerous plastic applications are already being utilized in the engine compartment.

By replacing traditional thermoplastic injection-molded parts with foamed plastics, an even greater weight reduction can be achieved. The importance of foamed plastics is constantly increasing, not only for automobile construction. In addition, as with traditional thermoplastic parts, high demands for strength are also being placed on foamed plastic parts.

Today the so-called MuCell method is frequently used for the production of foamed injection-molded parts. In this method, the thermoplastic material to be foamed is plasticized in a screw-type mixing extrusion machine, and a foaming agent is introduced into the screw-type mixing extrusion machine at a temperature and pressure at which it is a supercritical fluid. A completely single-phase solution of the plasticized material and the supercritical fluid is then formed in a diffusion chamber. By changing the temperature and the pressure upstream from the mixing worm, the foaming agent is released and a supermicrocellular foamed plastic is formed, which is distinguished by a very fine and uniform pore structure. Such a method is described, for example, in WO 92/17533.

DE 697 17 465 T2 discloses a method which attempts to do away with the inadequacies of the MuCell method. To this end, the propellant is inserted into the stream of molten polymeric material through a large number of openings along the extruder cylinder, in order to obtain an especially homogeneous single-phase solution of polymeric molten material and propellant.

To increase the strength of foamed materials, WO 02/26482 discloses a microcellular foamed molded piece produced according to the MuCell method, into which fibers with a length of at least 0.55 mm, in particular glass fibers, are incorporated. Through the use of a supercritical fluid as the propellant, it is supposedly possible to incorporate the glass fibers into the molded piece in an especially gentle manner, so that the length of the fibers is not reduced significantly during the incorporation. According to WO 02/26482, foamed microcellular molded pieces with average cell sizes smaller than 100 μm are obtained.

In contrast to the MuCell method, in which closed-pore foamed molded pieces are obtained, DE 100 05 873 A1 provides a way to achieve open-celled systems. In order to obtain an especially high degree of open-celled structure in extruded foam pieces, it is possible to use carbon dioxide or nitrogen as propellants, for example in combination with carbon particles as nucleating agents. In this way one obtains foam panels with adequate dimensional stability to heat.

Since the mechanical properties of foamed molded pieces normally can be improved when smaller cell sizes are used, DE 101 42 349 A1 modified the MuCell method by adding a silicon oil or cross-linked rubber with a particle size smaller than 1 μm to the thermoplastic melt as an additive. In this way, foamed thermoplastics with cell sizes ranging from 5 to 150 μm are obtained.

The influence of selected nucleating aids on the formation of foamed molded plastic pieces has been described in the dissertation of S. Schäper, “Nukleierung thermodynamisch getriebener Polyurethan-Reaktionsschäume” (“Nucleation of thermodynamically driven polyurethane reaction foams”), RWTH Aachen (Aachen University of Technology), 1977. It was found that neither activated charcoal with air absorbed on its surface nor powdered polytetrafluoroethylene (PTFE) significantly improve bubble formation or foam structure.

In both the non-foamed and foamed molded parts obtained with the methods taught by the existing art, shrinkage is always observed in the manufacturing process. For this reason, it is usually not possible to proceed without holding pressure during the shaping. An additional disadvantage, in particular when making interior body parts, is that warping is also often detected. Until now a great shortcoming of foamed molded plastic parts has been their visually unattractive surface, which is very rough. As a rule film-covered parts are utilized in the existing art. Numerous measures have already been proposed to optimize the surface of foamed molded parts. For example, when filling the molding die with the molten polymer, a so-called gas counterpressure process may be employed, in which the pressure ahead of the flowing front is elevated above a critical pressure. In this way, the formation of bubbles on the surface of the flowing front can be suppressed. However, this process is suitable only for thick-walled parts, since the formation of bubbles is suppressed not only on the surface itself, but in most cases in the entire leading layer of the foamed molded part. Alternatively, a two-component process may be used to optimize the surface, in which a first molten material that is free of bubbles, i.e. that contains no propellant, is first introduced through a sprue into the molding die. Immediately afterwards, a second molten material that is interspersed with a suitable propellant is introduced into the molding die. Since dissolved gases in the molten material greatly lower the viscosity of the molten material, special measures must be taken to ensure that the various components used in the molten material are coordinated with each other with respect to their flow behavior. However, because of the degasification of the core molten material, it is not possible to completely prevent the formation of shrinkage cavities between the two phases of molten material that have different consistencies.

Hence, it would be desirable to provide foamed plastic molded parts or methods for producing such molded parts that are not tainted by the shortcomings of the existing art. The present invention is therefore based on the task of providing a method for producing foamed plastic molded parts, whereby the parts exhibit little or no shrinkage, little or negligible warpage, very good noise and vibration damping, and which are distinguished by a visually attractive surface, without depending on additional measures or materials. The invention is also based on the task of providing foamed plastic pieces that are distinguished by very small average pore sizes.

The problem underlying the invention was solved by a method for the production of one or more foamed or pre-foamed molded parts and/or profiles and/or of foamed granulate, or of non-foamed and/or pre-foamed granulate, suitable for producing foamed or pre-foamed molded parts and/or profiles, using polymeric materials, comprising:
a) provision of prepolymeric and/or polymeric source material and/or of prepolymeric and/or polymeric source material containing nanoparticles and/or nanoparticle preliminary materials, prepared in each case with or without a physical and/or chemical propellant; and

of nanoparticles and/or nanoparticle preliminary material, prepared in each case with or without a physical and/or chemical propellant;
b) simultaneous or sequential mixing of the entire quantity or of part of the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, of the propellant and the nanoparticles, the nanoparticle preliminary material and/or the nanoparticles and/or nanoparticle preliminary materials prepared with a propellant, in at least one first container; or
   simultaneous or sequential mixing of the entire quantity or of part of the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and of the propellant, in at least one first container;
   simultaneous or sequential mixing of the entire quantity or of part of the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and of the nanoparticles, the nanoparticle preliminary materials and/or the nanoparticles and/or nanoparticle preliminary materials prepared with a propellant, in at least one first container;
   where each mixture contains nanoparticles and/or nanoparticle preliminary materials as separate components and/or on and/or in the source material, and propellant as a separate component and/or on and/or in the source material and/or the nanoparticles and/or nanoparticle preliminary materials;
c) introduction of the mixture of prepolymeric and/or polymeric source material and/or the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, nanoparticles, nanoparticle preliminary materials and/or the nanoparticles and/or nanoparticle preliminary materials prepared with a propellant, and the propellant; or, of the mixture of prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, nanoparticles, nanoparticle preliminary materials and/or the nanoparticles and/or nanoparticle preliminary materials prepared with a propellant, and the propellant; or of the mixture of prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and nanoparticles and/or nanoparticle preliminary materials and/or nanoparticles and/or nanoparticle preliminary materials prepared with a propellant, where at least the prepolymeric and/or polymeric source materials or the nanoparticles and/or nanoparticle preliminary materials are prepared with the propellant,
   in each case from at least one first container into a plasticizing unit or a mixing unit, to produce an at least partial polymeric molten material;
d) discharge of the polymeric molten material into at least one molding or continuous casting die, forming a foamed and/or pre-foamed molded part or profile, and removal or extraction of the molded part or profile from the molding or continuous casting die or removal or extraction of the molded part or profile prepared for forming;
   or granulation of the polymeric molten material, forming non-foamed, pre-foamed and/or foamed granulate.

According to another aspect, the problem underlying the invention was solved by a method for the production of one or more foamed molded parts and/or profiles and/or of foamed granulate, or of non-foamed and/or pre-foamed granulate, suitable for producing foamed or pre-foamed molded parts and/or profiles, using polymeric materials, comprising:
a) provision of prepolymeric and/or polymeric source material and/or of prepolymeric and/or polymeric source material containing nanoparticles and/or nanoparticle preliminary materials, prepared in each case with or without a physical and/or chemical propellant, physical and/or chemical propellants, and nanoparticles and/or nanoparticle preliminary material, prepared in each case with or without a physical and/or chemical propellant;
b) simultaneous or sequential mixing of the entire quantity or of part of the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, of the propellant and the nanoparticles, the nanoparticle preliminary material and/or the nanoparticles and/or nanoparticle preliminary materials prepared with a propellant, in at least one first container; or
   simultaneous or sequential mixing of the entire quantity or of part of the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and of the propellant, in at least one first container;
   simultaneous or sequential mixing of the entire quantity or of part of the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and of the nanoparticles, the nanoparticle preliminary materials and/or the nanoparticles and/or nanoparticle preliminary materials prepared with a propellant, in at least one first container;
c) introduction of the mixture of prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, nanoparticles, nanoparticle preliminary materials and/or the nanoparticles and/or nanoparticle preliminary materials prepared with a propellant, and the propellant; or, of the mixture of prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, nanoparticles, nanoparticle preliminary materials and/or the nanoparticles and/or nanoparticle preliminary materials prepared with a propellant, and the propellant; or, of the mixture of prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and nanoparticles and/or nanoparticle preliminary materials and/or nanoparticles and/or nanoparticle preliminary materials prepared with a propellant, where at least the prepolymeric and/or polymeric source materials or the nanoparticles and/or nanoparticle preliminary materials are prepared with the propellant, in each case from at least one first container into a plasticizing unit or mixing unit to produce an at least partial polymeric molten material, and introduction of nanoparticles and/or nanoparticle preliminary materials and/or nanoparticles and/or nanoparticle preliminary materials prepared with a propellant via the first and/or at least one second container into the plasticizing unit or a mixing unit which is positioned downstream or upstream from the position of the introduction via the first container, and
d) discharge of the polymeric molten material into at least one molding or continuous casting die, forming a foamed and/or pre-foamed molded part or profile, and removal or extraction of the molded part or profile from the molding or continuous casting die or removal or extraction of the molded part or profile prepared for forming;
   or granulation of the polymeric molten material, forming non-foamed, pre-foamed and/or foamed granulate.

At the same time there can be provision so that in at least one mixture, aside from prepolymeric and/or polymeric source materials containing nanoparticles and/or nanoparticle preliminary materials, in which essentially no additional separate nanoparticles and/or nanoparticle preliminary materials are employed.

In principle, the method according to one embodiment of the invention can be carried out on all injection molding and extrusion devices or press systems with which foamed plastic materials are made according to traditional methods. This also applies in particular to processing machines like those used for carrying out the MuCell method, for example according to DE 692 32 415 T2. Accordingly, one embodiment of the method according to the invention also represents a refinement of the MuCell method; however it is not limited to that, but can be implemented in principle with all manufacturing methods for foamed plastic molded parts. In the method according to one embodiment of the invention, it is always important to make sure that a material is used that is flowable at least in the plasticizing unit, at least parts of which include the two-phase system liquid/gaseous, and that has a continuous liquid phase, with the material being capable of losing its flowability again when the temperature falls. In natural rubbers and other thermosetting materials, on the other hand, when heat is added, the matrix material can become cross-linked above critical temperatures and can thus lose its flowability.

In one embodiment of the invention, it has proven beneficial to subject the plastic source material to a prior preparation stage, i.e. treatment with a propellant. This can take place, for example, in a first container, which in this case constitutes an autoclave, which is connected or may be connected to a plasticizing unit. In one embodiment, it is possible to subject the plastic source material, the propellant, and the nanoparticles jointly to this preparation stage or, alternately, to provide only the plastic source material and the propellant for the preparation stage. In the latter case the nanoparticles are fed at least partially separately to the plasticizing unit. In general, the order of mixing the individual components can be varied in broad ranges.

According to a refinement of the method according to another embodiment of the invention, a provision is made for part of the nanoparticles and/or nanoparticle preliminary materials and/or of the nanoparticles and/or nanoparticle preliminary materials prepared with a propellant to be mixed with part of the prepolymeric and/or polymeric source material in at least one container, and for the mixture obtained, prior to being introduced into a plasticizing unit or mixing unit, to be mixed to the point of saturation or partial saturation with that propellant and/or stored in it.

At the same time, in one embodiment, a provision can be made for the nanoparticle preliminary materials in the first container, the second container and/or the plasticizing unit or the mixing unit to be partially, nearly completely or completely transformed into nanoparticles and to be divided and distributed in the plasticizing unit or the mixing unit, in particular essentially uniformly, in the polymeric molten material or the prepolymeric source material.

Based on considerations of practicality, it has proven to be beneficial if one first mixes the nanoparticles and the plastic source material and then mixes this mixture with the propellant.

At the same time, a provision can be made according to the invention for the remainder of the nanoparticles and/or nanoparticle preliminary materials and/or of the nanoparticles and/or nanoparticle preliminary materials prepared with a propellant and/or the remainder of the prepolymeric and/or polymeric source material to be mixed with the mixture of prepolymeric and/or polymeric source material, nanoparticles and/or nanoparticle preliminary materials and/or of the nanoparticles and/or nanoparticle preliminary materials prepared with a propellant and the propellant in a first container, or to be fed separately, in particular through at least one second container, to the plasticizing unit or mixing unit.

The method according to one embodiment of the invention takes especially effective shape when the prepolymeric and/or polymeric source material or a part thereof and/or the nanoparticles and/or nanoparticle preliminary materials and/or the nanoparticles and/or nanoparticle preliminary materials prepared with a propellant is or are stored in the propellant at a pressure and a temperature, in particular until the prepolymeric and/or polymeric source material and/or the nanoparticles and/or nanoparticle preliminary materials and/or the nanoparticles and/or nanoparticle preliminary materials prepared with a propellant are nearly or essentially completely saturated with the propellant or have reached a specified degree of saturation. Accordingly, in one embodiment the external addition of propellants can also be dispensed with if at least part of the materials used have been prepared beforehand with a propellant.

Thus in a preferred embodiment, the plastic source material, which is usually present in the form of a plastic granulate, is exposed to the propellant under more severe conditions before being introduced into the plasticizing unit. Accordingly, provision can be made for the propellant and the prepolymeric and/or polymeric source material, the nanoparticles and/or the nanoparticle preliminary material to be subjected to elevated pressure and/or to an elevated temperature before being introduced into the plasticizing unit or mixing unit. Naturally, in addition or alternately, the nanoparticles and/or the nanoparticle preliminary materials can also be stored in the propellant or if appropriate be subjected to these more severe conditions before being mixed with the prepolymeric and/or polymeric source material or part thereof.

This happens expediently in an autoclave, in which the propellant is kept under the necessary pressure and at the necessary temperature. The propellant is present in the autoclave, in particular in a supercritical state. The plastic source material thus mixed with propellant can then be transferred to the plasticizing unit in the manner known to a person skilled in the art, and be melted down.

According to another embodiment, provision is therefore made for all nanoparticles and/or nanoparticle preliminary materials to be fed through at least one second container to the plasticizing unit. Of course, the nanoparticles introduced via the second container into the plasticizing unit can also be treated partially or in their entirety separately with a propellant and be introduced into the plasticizing unit together with that propellant.

In addition, care must be taken to ensure that the preparation and mixing of the individual components is carried out in such a way that at most a moderate adhesion, but in particular no adhesion results between the plastic source material and the nanoparticles. The worse the adhesion between the components, the more advantageous is the formation of a uniform, fine-pored foam structure. Because the more incomplete the cross-linking is between the polymeric molten material and the nanoparticles, the more quickly the formation of nuclei normally begins. Especially preferred for example are systems of plastic molten material and nanoparticles in which a wetting contact angle smaller than 30° results.

In an especially practical configuration of the method according to one embodiment of the invention, nanoparticles with a tight grain size distribution are used. In this way an especially uniform foam structure with a large number of very small pores is obtained.

Especially satisfying results, in particular with regard to visually acceptable surfaces, can be obtained when at least part of the nanoparticle preliminary material and/or of the nanoparticles are pretreated in the plasticizing unit or mixing unit with an adhesive agent or preferably an anti-adhesive agent before being put into a polymeric molten material containing the prepolymeric and/or polymeric source material. Suitable anti-adhesive agents are, for example, greases or substances with related properties. Alternatively, in addition to or instead of the anti-adhesive agents, when producing the nanoparticles one can dispense with wetting them with adhesion promoters. A suitable method of producing such nanoparticles can be readily conceived, for example, on the basis of those in the Encyclopedia ofPolymer Science and Engineering, 2nd edition, Vol. 4, pages 284 to 298, by omitting the adhesion promoters provided there at the respective stage of the process. Furthermore, according to another embodiment, one can coordinate the polarity of the polymer materials and the propellants with each other in order to suppress the adhesion phenomena described above. For example, according to a preferred embodiment, with non-polarized polymer materials such as polyolefins, water can be used as the propellant. On the other hand, if polarized polymer materials are to be foamed, for example polyamides, polyesters, polyurethanes or polyethers, it is advisable to use a non-polarized propellant, for example supercritical nitrogen or supercritical carbon dioxide. Preferably, the nanoparticles are also pretreated in each case with the corresponding propellants. Of course it is possible in addition or at the same time to utilize compounds as anti-adhesion agents that differ greatly in their polarized or non-polarized character from the polarized or non-polarized nature of the nanoparticles or nanoparticle preliminary materials. For example, if polarized nanoparticles or nanoparticle preliminary materials are present, a non-polarized substance is preferably employed as anti-adhesion agent. The same applies in reverse for non-polarized nanoparticles.

Possibilities for polymeric plastic source material include, for example, thermoplastic polymers and thermoplastic elastomers, both preferably in granulate form. Suitable thermoplastic polymers can be selected, for example, from the group comprising polyolefins, ASA polymerizates, ABS polymerizates, polycarbonates, polyesters, polyamides, polyethers, polyimides, polystyrenes, polyurethanes, polyether ketones, polystyrenes, polyurethanes, polyphenylene sulfides, polyphenylene ethers, poly(meth)acrylates, poly(meth)acrylamides, poly(meth)acrylnitrile, polysulfones, polyvinyl chlorides, SAN polymerizates, epoxy resins, phenolic resin polymers, each in impact-resistant modified and non-impact-resistant modified form, and mixtures thereof. Thermoplastic synthetics and their production are known in general to the person skilled in the art.

Possibilities for thermoplastic elastomers are for example the S-EB-S, SBS-SIS, EPDM/PP, polyamide, polyester or TPU systems, known to a person skilled in the art.

Suitable polymeric source materials also include duroplastic polymers and/or reactive elastomers. Furthermore, suitable prepolymeric source materials include preliminary products of duroplastic polymers and/or reactive elastomers.

Another embodiment of the method according to the invention provides for the prepolymeric source material to be polymerized in the plasticizing unit or the mixing unit or a downstream unit.

Suitable prepolymeric source materials include, for example, non-cross-linked or partially cross-linked rubbers, a mixture of at least one polyol and at least one isocyanate, or cationically or anionically polymerizable monomers.

In the present case, nanoparticles should be understood to mean particles whose size is in the nanometer range, i.e. in the range from about 0.5×10⁻⁹ to 10⁻⁶ m. Materials with a larger particle size are referred to in general in the sense of the present invention as nanoparticle preliminary materials, it being possible also for these preliminary materials to be present in sizes smaller than 10⁻⁶ m.

Possibilities for nanoparticles include, for example, all of the types known to the person skilled in the art, including in particular those that are accessible from nanoparticle preliminary materials in delaminated or exfoliated form. One may draw here on phyllosilicates, in particular on montmorillonite, smectite, ellite, sepiolite, palygorskite, muscovite, allivardite, amesite, hectorite, fluorohectorite, saponite, beidellite, talcum, nontronite, stevensite, bentonite, mica, vermiculite, fluorovermiculite, halloysite types of synthetic talcum containing fluorine, as well as mixtures of the above. Exfoliated nanoparticles or delaminated phyllosilicates in the meaning of the present invention should be understood to mean, for example, substances in which the layer intervals are first enlarged through conversion with so-called hydrophobing agents followed by steeping as appropriate, for example by adding monomers such as caprolactam. Also suitable are titanium or silicon compounds obtainable through the sol-gel process. Among the silicon compounds from the sol-gel process, special preference is given to pyrogenic silicic acid. Descriptions of suitable SiO₂, SiO₂-C and TiO₂ nanoparticles and powders are also found in the dissertation of F. Locke, “Herstellung und Charakterisierung von SiO₂, SiO₂-C und TiO₂ Nanopartikeln” (“Production and characterization of SiO₂, SiO₂-C and TiO₂ nanoparticles”) (November 2002, Freiberg Technical University). Also worthy of consideration as so-called nanopowders are those for example of A1₂O₃, ZrO₂, Ti, TiB₂, TiC and TiN. These powders can be produced for example by means of flame aerosol, plasma, sol-gel or laser ablation processes.

Other possibilities for nanoparticle preliminary materials and/or nanoparticles also include soots, and in particular nano tubes. Suitable nano tubes, for example those with a diameter in the range from a few, for example 1 nm, up to some hundreds of nanometers, for example 900 nm, can be made of a plastic material such as polytetrafluoroethylene, polystyrene or polymethyl methacrylate, as described in Science, Jun. 14, 2002. Suitable carbon nano tubes can be obtained, for example, according to the method disclosed in DE 102 57 025 A1 and EP 1 059 266 A1, as well as in Iijima, S., Nature, 354:56-58 (1991), and Ebbesen, T. W. and Ajayan, P. M., Nature, 358:195-196 (1992).

It is advantageous here if the average length and/or width of the nanoparticles employed is in the range from 10 to 700 nm, in particular in the range from 20 to 500, preferably 250 nm, and the average thickness or radius of these nanoparticles is in the range from 1 to 250 nm, preferably from 1 to 80 nm, especially preferably from 1 to 50 nm and in particular from 1 to 10 nm.

By preference, nanoparticle preliminary materials can be divided and/or defoliated into suitable nanoparticles in a kneading or compounder unit and/or the plasticizing unit.

In principle it is possible to use either chemical or physical propellants, or mixtures of both propellant types. Possibilities for suitable propellants include for example azo and diazo compounds, in particular azodicarboxylic acid diamide, sulfohydrazides, semicarbazides, citric acid and its esters, peroxo, triazine, tetrazole, tetrazone or tetramine compounds and alkali or alkaline earth carbonates, in particular bicarbonate compounds. Suitable physical propellants are represented by water, methanol, ethanol, dimethyl ether, methane, ethane, i- or n-propane, n-butane, n- or i-pentane, cyclopentane, hexanes, heptanes, heptenes, benzene and its derivatives, chlorofluorocarbons, carbon dioxide or nitrogen or the like. The named saturated and unsaturated hydrocarbons can be utilized in every isomeric form. Especially satisfying results occur when water, carbon dioxide and nitrogen are used.

In order to obtain a good surface of the foamed molded piece, it is advisable to use water, carbon dioxide and nitrogen in the supercritical state.

Another factor contributing to a flawless surface is for the molding die, in particular when using thermoplastic source materials, or at least an area of the molding die, or at least an area of the inside of the molding die, at least during a part of the process of filling with the polymeric molten material and/or at least during part of the cooling process of the molding material that forms the molded part, to be at a temperature that is above room temperature, in particular above the softening temperature of the molding material that forms the molded part. Suitable molding dies, with which the die wall can be adjusted to a high temperature, for example close to the melting temperature of the molding material at the moment of contact of the molten material, are either already available commercially or can be constructed readily in the manner known to a person skilled in the art. For example, such dies can have tempering channels in the area of the die surface which are connected to a steam circulation system.

A preferred embodiment includes the provision, in particular for the production of profiles or molded parts from partially crystallized solidifying thermoplastics, for at least a part of at least the surface of the molding die to have a temperature that lies approximately 5° C. to 20° C. below the softening temperature or the crystallization temperature of the molding material that forms the molded part or profile.

It is also preferred if, for the production of profiles or molded parts from amorphously solidifying molten materials, at least part of at least the surface of the molding die is at a temperature that is approximately 5° C. to 30° C. above the softening temperature of the molding material that forms the molded part or profile.

An advantageous effect with regard to the surface properties of the foamed plastic molded parts also appears if at least part, in particular the surface, of the molding die is a poor conductor of heat. Poor heat conduction in the meaning of the present invention should characterize, for example, dies of steel, in particular high-alloy steels, and/or titanium. Suitable materials with poor heat conductivity also include ceramics and plastics. It is also possible, alternately or in addition, to provide at least certain areas of the inside wall of the molding die with at least one heat-blocking layer or coating, for example a plastic or ceramic coating. Suitable plastic coatings are based for example on polystyrene, including syndiotactic polystyrene, or polytetrafluoroethylene (PTFE), or on suitable synthetic resins such as phenol, epoxy, polyester or silicon resins. In general, coating thicknesses in the range of as little as 0.2 to 0.8 mm are adequate, with a coating thickness of about 0.4 mm having proven adequate for many applications.

It is of course possible, independently of the quality of the surface obtained, to apply a layer of film to at least part of the surface of the molding die before filling the molding die. Procedures for foaming-in behind films, as well as the possible films for these procedures, are sufficiently known to a person skilled in the art.

The method according to the invention can be undertaken on normal commercial injection molding equipment, press systems or extruders, for which reason the plasticizing unit can be a component of such a die casting device or such a device itself. Suitable press systems include for example a press and the associated die. The molding die or the press system may be filled with gas under elevated pressure before being filled with the polymeric molten material.

A suitable combination of equipment for carrying out the method according to the invention may consist, for example, of an injection molding machine that is provided with a heat-insulated and pressure-resistant input funnel, which in turn is connected via a gate to a first container in the form of an autoclave, in which the particular plastic source material is treated, in particular saturated, with the propellant. The plastic source material treated with the propellant can then be metered into the plasticizing unit of the injection molding machine as needed, through a gate and the input funnel. This material is seized by the plasticizer worm and drawn in.

It is also of particular advantage to use prepolymeric and/or polymeric source materials, in particular in the form of plastic granulates, that already contain at least one chemical and/or physical propellant in addition to the nanoparticles or nanoparticle preliminary materials. These source materials can be present and be utilized in completely non-foamed condition, or already in pre-foamed or partially foamed condition. The use of these source materials greatly simplifies the method according to one embodiment of the invention, and makes the separate addition of propellants and nanoparticles superfluous. It is also advantageous here that these plastic source materials or granulates themselves can be obtained by the method according to one embodiment of the invention.

Granulation of the molten polymer by the method according to one embodiment of the invention by forming non-foamed granulate can be brought about, for example, by keeping the pressure in the plasticizing unit or mixing unit high enough so that the propellant introduced into these devices is not given an opportunity to foam. Instead, the propellant remains dissolved in the molten material. In a suitable embodiment, the plasticizing unit or mixing unit may have at least one cooling area, for example in the direction or area where the molten material emerges, for example in the form of a cooling extruder, so that when the molten material emerges from the die the propellant remains in the solidified or solidifying non-foamed or slightly foamed granulate. In one embodiment, this molten material that has already been cooled down can be placed for example directly in a cooled water bath, forming a granulate under known conditions.

Consequently the nanoparticles and the propellant are present side-by-side in this non-foamed granulate. It is of course possible to manage the temperature and/or pressure pattern in the procedural variant described above in such a way that the granulate is foamed only a little, i.e. is slightly foamed or pre-foamed, and that there is still always enough propellant present in the granulate so that it can be employed to produce foamed molded parts or profiles. It is also possible, in principle, to produce not only non-foamed granulates using the method according to one embodiment of the invention. It is also possible to obtain molded parts and profiles in the slightly foamed or pre-foamed state, so that when they are heated again, complete foaming can be brought about.

The non-foamed or pre-foamed plastic source materials according to one embodiment of the invention also have the advantage that they can be utilized and sold as a master batch. By mixing in a plastic source material that contains no propellant, an intentional emaciation can be used to set a desired pore density or distribution. The plastic source materials can be blended homogeneously, for example, before being introduced into a plasticizing unit or mixing unit. In addition, the source material according to one embodiment of the invention can be added to the source material that is already present in the plasticizing unit, in particular at least partially as a molten polymer material, which contains no propellant. The opposite procedure is of course also possible.

The method according to one embodiment of the invention provides access to foamed plastic parts that are distinguished by a very uniform, fine-pored foam structure, with average pore size smaller than 100 μm, preferably smaller than 10 μm, and especially preferably smaller than 1 μm. Consequently, the plastic pieces according to the invention have average pore sizes that are smaller than the pore sizes of traditional foamed pieces from the existing art. Suitable molded pieces, profiles, or granulates according to the invention have, for example, average pore sizes in the range from 0.1 to 10 μm. The molded parts obtained in this way exhibit practically no shrinkage, which makes it possible to work without holding pressure. Likewise, internal stresses do not occur or occur only to a lesser degree, so that warpage of parts is no longer found. Also of particular advantage is the fact that the polymeric molten material obtained makes it possible to work with larger or lighter mold clamping units.

In particular, however, the plastic molded parts obtained with the method according to one embodiment of the invention are distinguished by a visually acceptable surface, which is already adequate for example to permit visible applications in automobile construction without any need for further corrective steps. Also of particular advantage is the very high degree of sound and vibration damping that can be achieved with the plastic pieces according to one embodiment of the invention.

Without knowing the details that contribute to the success of the method according to embodiments of the invention, it is assumed at present that under the processing conditions found, in a polymeric molten material of plastic granulate saturated with a propellant and nanoparticles, there are a large number of very small nuclei present that serve as the starting point for the fine-scaled pore formation that is detected. It could be of significance here that care is taken to ensure that the overpressure of the gas in the nucleus is sufficiently great to overcome the surface tension. As is known, the surface tension is inversely proportional to the size of the boundary surface that the nucleus offers for the forming bubble.

Accordingly, for nuclei with a diameter of about 500 nm a relatively high overpressure of the propellant at the surface of the nucleus is required. As explained earlier, possibilities for this include in particular plastic source materials that have been stored for some time in a physical or chemical propellant, in particular in supercritical carbon dioxide or nitrogen.

The features of the invention that are disclosed in the preceding description and in the claims may be essential both individually and in every possible combination for realizing the invention in its various embodiments.

1. A method for the production of one or more foamed or pre-foamed molded parts and/or profiles, and/or the production of foamed, non-foamed and/or pre-foamed granulate suitable for producing foamed or pre-foamed molded parts and/or profiles, using polymeric materials, comprising:
a) provision of (1) prepolymeric and/or polymeric source material and/or prepolymeric and/or polymeric source material containing nanoparticles and/or nanoparticle preliminary materials, prepared in each case with or without a physical and/or chemical propellant, (2) physical and/or chemical propellant, and (3) nanoparticles and/or nanoparticle preliminary material, prepared in each case with or without a physical and/or chemical propellant;
b) simultaneous or sequential mixing of (1) the entire quantity or part of the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, (2) the propellant, and (3) the nanoparticles, the nanoparticle preliminary material and/or the nanoparticles and/or nanoparticle preliminary materials prepared with a propellant, in at least one first container; or
simultaneous or sequential mixing of (1) the entire quantity or part of the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the propellant, in at least one first container; or
simultaneous or sequential mixing of (1) the entire quantity or part of the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the nanoparticles, the nanoparticle preliminary materials and/or the nanoparticles and/or nanoparticle preliminary materials prepared with a propellant, in at least one first container;
where each mixture contains (1) nanoparticles and/or nanoparticle preliminary materials as separate components and/or on and/or in the source material, and (2) propellant as a separate component and/or on and/or in the source material and/or the nanoparticles and/or nanoparticle preliminary materials;
c) introduction of the mixture of (1) the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, (2) the nanoparticles, nanoparticle preliminary materials and/or the nanoparticles and/or nanoparticle preliminary materials prepared with a propellant, and (3) the propellant; or,
of the mixture of (1) the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the propellant; or
of the mixture of (1) the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the nanoparticles and/or nanoparticle preliminary materials and/or nanoparticles and/or nanoparticle preliminary materials prepared with a propellant, where at least the prepolymeric and/or polymeric source materials or the nanoparticles and/or nanoparticle preliminary materials are prepared with the propellant,
in each case from the at least one first container into a plasticizing unit or mixing unit to produce an at least partial polymeric molten material; and
d) discharge of the polymeric molten material into at least one molding or continuous casting die, forming a foamed and/or pre-foamed molded part or profile, and removal or extraction of the molded part or profile from the molding or continuous casting die or removal or extraction of the molded part or profile prepared for forming;
or granulation of the polymeric molten material, forming non-foamed, pre-foamed and/or foamed granulate.

2. A method for the production of one or more foamed molded parts and/or profiles, and/or the production of foamed, non-foamed and/or pre-foamed granulate suitable for producing foamed or pre-foamed molded parts and/or profiles, using polymeric materials, comprising:
a) provision of (1) prepolymeric and/or polymeric source material and/or prepolymeric and/or polymeric source material containing nanoparticles and/or nanoparticle preliminary materials, prepared in each case with or without a physical and/or chemical propellant, (2) physical and/or chemical propellant, and (3) nanoparticles and/or nanoparticle preliminary material, prepared in each case with or without a physical and/or chemical propellant;
b) simultaneous or sequential mixing of (1) the entire quantity or part of the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, (2) the propellant, and (3) the nanoparticles, the nanoparticle preliminary material and/or the nanoparticles and/or nanoparticle preliminary materials prepared with a propellant, in at least one first container; or
simultaneous or sequential mixing of (1) the entire quantity or part of the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the propellant, in at least one first container; or
simultaneous or sequential mixing of (1) the entire quantity or part of the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the nanoparticles, the nanoparticle preliminary materials and/or the nanoparticles and/or nanoparticle preliminary materials prepared with a propellant, in at least one first container;
c) introduction of the mixture of (1) the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, (2) the nanoparticles, nanoparticle preliminary materials and/or the nanoparticles and/or nanoparticle preliminary materials prepared with a propellant, and (3) the propellant; or
of the mixture of (1) the prepolymeric and/or polymeric source material and/or of the prepolymeric and/or polymeric source material prepared with a propellant and/or of the prepolymeric and/or polymeric source material containing nanoparticles and/or nanoparticle preliminary materials, prepared in each case with or without a physical and/or chemical propellant, and (2) the propellant; or
of the mixture of (1) the prepolymeric and/or polymeric source material and/or the prepolymeric and/or polymeric source material prepared with a propellant and/or the prepolymeric and/or polymeric source material containing nanoparticles and/or nanoparticle preliminary materials, prepared in each case with or without a physical and/or chemical propellant, and (2) the nanoparticles and/or nanoparticle preliminary materials and/or nanoparticles and/or nanoparticle preliminary materials prepared with a propellant, where at least the prepolymeric and/or polymeric source materials or the nanoparticles and/or nanoparticle preliminary materials are prepared with the propellant,
in each case from the at least one first container into a plasticizing unit or mixing unit to produce an at least partial polymeric molten material, and
introduction of nanoparticles and/or nanoparticle preliminary materials and/or nanoparticles and/or nanoparticle preliminary materials prepared with a propellant via the first and/or at least one second container into the plasticizing unit or mixing unit which is positioned downstream or upstream from the position of the introduction via the first container, and
d) discharge of the polymeric molten material into at least one molding or continuous casting die, forming a foamed and/or pre-foamed molded part or profile, and removal or extraction of the molded part or profile from the molding or continuous casting die or removal or extraction of the molded part or profile prepared for forming;
or granulation of the polymeric molten material, formying noln-foamed, pre-foamed and/or foamed granulate.

3. A method according to claim 1, characterized in that in at least one mixture, aside from prepolymeric and/or polymeric source materials containing nanoparticles and/or nanoparticle preliminary materials, essentially no additional separate nanoparticles and/or nanoparticle preliminary materials are employed.

4. A method according to claim 1, characterized in that part of (1) the nanoparticles and/or nanoparticle preliminary materials and/or part of (2) the nanoparticles and/or nanoparticle preliminary materials prepared with a propellant is mixed with part of the prepolym eric and/or polymeric source material in the at least one first container, and that the mixture obtained, prior to being introduced into the plasticizing unit or mixing unit, is mixed to the point of saturation or partial saturation with the propellant and/or is stored in the propellant.

5. A method according to claim 1, characterized in that the rianoparticle preliminary materials in the first container and/or plasticizing unit or the mixing unit are partially, nearly completely or completely transformed into nanoparticles and are divided and distributed in the plasticizing unit or mixing unit essentially uniformly in the polymeric molten mnaterial or the prepolymeric source material.

6. A method according to claim 5, characterized in that the transformation of the nanoparticle preliminary materials to nanoparticles is obtained by dividing and/or defoliating the nanoparticle preliminary materials by means of shearing in a kneading or compounder ulnit and/or the plasticizing unit.

7. A method according to claim 4, characterized in that a remainder of (1) the nanoparticles and/or nanoparticle preliminary materials and/or the nanoparticles and/or narioparticle preliminary materials prepared with a propellant, and/or a remainder of (2) the prepolymeric and/or polymeric source material, is mixed with the mixture of prepolynieric and/or polymeric source material, nanoparticles and/or nanoparticle preliminary materials, ard/or the nanoparticles arid/or nanoparticle preliminary materials prepared with a propellant, and the propellant, in the first container, or is fed separately through at least one second container to the plasticizing unit or mixing unit.

8. A method according to claim 1, characterized in that the prepolymeric and/or polymeric source material or a part thereof and/or the nanoparticles and/or nanoparticle preliminary materials and/or the nanoparticles and/or nanoparticle prelimiiiary materials prepared with a propellant is or are stored in the propellant at a pressure and a temperature until the prepolymeric and/or polymeric source material and/or the nanoparticles and/or nanoparticle preliminary materials and/or the rianoparticles and/or nanoparticle preliminary materials prepared with a propellant are nearly or essentially completely saturated with the propellant or have reached a specified degree of saturation.

9. A method according to claim 8, characterized in that the nanoparticles and/or the nanoparticle preliminary materials are stored in the propellant before being miixed with the prepolymeric and/or polymeric source material or a part thereof.

10. A method according to claim 1, characterized in that the propellant and the prepolymeric and/or polymeric source material, the nanoparticles and/or the nanoparticle preliminary material are subjected to an elevated pressure and/or to an elevated temperature before being introduced into the plasticizing unit or mixing unit.

11. A method according to claim 1, characterized in that all nanoparticles and/or nanoparticle preliminary materials are fed through at least one second container to the plasticizing unit.

12. A method according to claim 1, characterized in that at least part of the nanoparticle preliminary material and/or the nanoparticles are pre-treated in the plasticizing unit or mixing unit with an adhesion agent or an anti-adhesion agent before being introduced into the polymeric molten material containing the prepolymeric and/or polymeric source material.

13. A method according to claim 1, characterized in that the prepolymeric source material is polymerized in the plasticizing unit or mixing unit or in a downstream unit.

14. A method according to claim 1, characterized in that the prepolymeric source material includes non-cross-linked or partially cross-linked natural rubbers, a mixture of at least one polyol and at least one isocyanate, or cationically or anionically polymerizable monomers.

15. A method according to claim 1, characterized in that the polymeric source material inchldes a thermoplastic polymer and/or a thermoplastic elastomer.

16. A method according to claim 1, characterized in that the polymeric source material is selected from the group comprising polyolefins, ASA polymerizates, ABS polymerizates, polycarbonates, polyesters, polyamides, polyethers, polyimides, polyether ketones, polystyrenes, polyurethanes, polyphenylene sulfides, polyphenylene ethers, polyacrylates, polyacrylamides, polyacrylnitrile, polysulfones, polyvinyl chlorides, SAN polymerizates, epoxy resins, phenolic resins, each in impact-resistant modified and non-impact-resistant modified form, and mixtures thereof.

17. A method according to claim 1, characterized in that the polymeric source material contains duroplastic polymers and/or reactive elastomers and/or that the prepolymeric source material contains preliminary products of duroplastic polymers and/or reactive elastomers.

18. A method according to claim 1, characterized in that (1) phyllosilicates, in particular montmorillonite, smectite, ellite, sepiolite, palygorskite, muscovite, allivardite, amesite, hectorite, fluorohectorite, saponite, beidellite, talcum, nontronite, stevensite, bentonite, mica, vermiculite, fluorovermiculite, halloysite and synthetic talcum types containing fluorine and mixtures of the above, and/or (2) at least one silicon compound suitable for a sol-gel process, in particular pyrogenic silicic acid, and/or (3) soots produced on the basis of carbon, and/or (4) nano tubes or powders, are utilized as nanoparticle preliminary material and/or as nanoparticles.

19. A method according to claim 1, characterized in that an average length and/or width of the nanoparticles employed lies in a range from 20 to 500 nm and/or an average thickness and/or radius of these nanoparticles lies in a range from 1 to 250 nm.

20. A method according to claim 1, characterized in that the chemical propellant is selected from the group comprising azo and diazo compounds, in particular azodicarboxylic acid diamide, sulfohydrazides, semicarbazides, citric acid and its esters, peroxo, triazine, tetrazole, tetrazone or tetramine compounds, and alkali or alkaline earth carbonates, in particular bicarbonate compounds.

21. A method according to claim 1, characterized in that the physical propellant is selected from the group comprising water, methanol, ethanol, dimethyl ether, methane, ethane, n- or i-propane, n-butane, n- or i-pentane, cyclopentane, hexanes, heptanes, heptenes, benzenes, chlorofluorocarbons, carbon dioxide or nitrogen.

22. A method according to claim 21, characterized in that water, carbon dioxide and nitrogen in supercritical condition are utilized.

23. A method according to claim 1, characterized in that when using thermoplastic source materials, at least an area of the molding die, or at least an area of the inside of the molding die, at least during part of a process of filling the die with the polymeric molten material and/or at least during part of a cooling process of the molten material that forms the molded part, is at a temperature that is above room temperature, in particular above the softening temperature of the molten material that forms the molded part.

24. A method according to claim 1, characterized in that for the production of profiles or molded parts from partially crystallized solidifying thermoplastics, at least part of at least the surface of the molding die is at a temperature that lies approximately 5° C. to 20° C. below the softening temperature or the crystallization temperature of the molten material that forms the molded part or profile.

25. A method according to claim 1, characterized in that for the production of profiles or molded parts from amorphously solidifying the molten material, at least part of at least the surface of the molding die is at a temperature that lies approximately 5° C. to 30° C. above the softening temperature of the molten material that forms the molded part or profile.

26. A method according to claim 1, characterized in that at least part of the molding die is a poor conductor of heat, includes in particular steel, high-alloy steels and/or titanium, and is provided with a ceramic and/or plastic coating.

27. A method according to claim 1, characterized in that before the molding die is filled with the polymeric molten material, a layer of film is placed on at least part of the surface of the molding die.

28. A method according to claim 1, characterized in that the plasticizing unit is a component of a die casting device, a press system or an extruder, or is a die casting tool, a press system or an extruder.

29. A method according to claim 28, characterized in that the molding die or the press system is filled with gas under elevated pressure before being filled with the polymeric molten material.

30. A molded part obtainable according to the method of claim 1.

31. A profile obtainable according to the method of claim 1.

32. A granulate obtainable according to the method of claim 1.

33. A granllate according to claim 32, characterized in that the granulate is present in non-foamed and/or pre-foamed form.

34. A plastic source material containing nanoparticles and/or nanoparticle preliminary materials and at least one physical and/or chemical propellant.

35. A plastic source material according to claim 34, characterized in that it is present in non-foamed and/or pre-foamed condition.

36. A plastic source material according to claim 34, characterized in that it is a plastic granulate.

37. A plastic source material according to claim 35, characterized in that it is a plastic granulate.

38. A method according to claim 2, characterized in that in at least one mixture, aside from prepolymeric and/or polymeric source materials containing nanoparticles and/or nanioparticle preliminary materials, essentially no additional separate nanoparticles and/or nanoparticle preliminary materials are employed.

39. A method according to claim 2, characterized in that part of (1) the nianioparticles and/or nanoparticle preliminary materials and/or part of (2) the nanoparticles and/or nanopaiticle preliminary materials prepared with a propellant is mixed with part of the prepolymeric and/or polymeric source material in the at least one first container, and that the mixture obtained, prior to being introduced into the plasticizing unit or mixing unit, is mixed to the point of saturation or partial saturation with the propellant and/or is stored in the propellant.

40. A method according to claims 2, characterized in that the nanoparticle preliminary materials in the first container, the second container and/or the plasticizing unit or mixing unit are partially, nearly completely or completely transformed into nanoparticles and are divided and distributed in the plasticizing unit or mixing unit essentially uniformly in the polymeric molten material or the prepolymeric source material.

41. A method according to claim 40, characterized in that the transforination of the nanoparticle preliminary materials to nanoparticles is obtained by dividing and/or defoliatirig the nanoparticle preliminary materials by means of shearing in a kneading or compounder unit and/or the plasticizing unit.

42. A method according to claim 39, characterized in that a remainder of (1) the nanioparticles and/or nanoparticle preliminary materials and/or the nanoparticles and/or nanoparticle preliminary materials prepared with a propellant, and/or a remainder of (2) the prepolymeric and/or polymeric source material, is mixed with the mixture of prepolyineric and/or polymeric source material, nanoparticles and/or nanoparticle preliminary materials, and/or the nanoparticles and/or nanoparticle preliminary materials prepared with a propellant, and the propellant, in the first container, or is fed separately through the at least one second container to the plasticizing unit or mixing unit.

43. A method according to claim 2, characterized in that the prepolymeric and/or polymeric source material or a part thereof and/or the nanoparticles and/or nanoparticle preliminary materials and/or the nanoparticles and/or nanoparticle preliminary materials prepared with a propellant is or are stored in the propellant at a pressure and a temperature until the prepolymneric and/or polymeric source material and/or the nanoparticles and/or nanoparticle preliminary materials and/or the nanoparticles and/or nanoparticle preliminary materials prepared with a propellant are nearly or essentially completely saturated with the propellant or have reached a specified degree of saturation.

44. A method according to claim 43, characterized in that the nanoparticles and/or the nanoparticle preliminary materials are stored in the propellant before being mixed with the prepolymeric and/or polymeric source material or a part thereof.

45. A method according to claim 2, characterized in that the propellant and the prepolymeric and/or polymeric source material, the nanoparticles and/or the nanoparticle preliminary material are subjected to an elevated pressure and/or to an elevated temperature before being introduced into the plasticizing unit or mixing unit.

46. A method according to claim 2, characterized in that all nanoparticles and/or nianoparticle preliminary materials are fed through at least one second container to the plasticizing unit.

47. A method according to claim 2, characterized in that at least part of the nanoparticle preliminary material and/or the nanoparticles are pre-treated in the plasticizing unit or mixing unit with an adhesion agent or an anti-adhesion agent before being introduced into the polymeric molten material containing the prepolymeric and/or polymeric source material.

48. A method according to claim 2, characterized in that the prepolymeric source material is polymerized in the plasticizing unit or mixing unit or in a downstream unit.

49. A method according to claim 2, characterized in that the prepolymeric source material includes non-cross-linked or partially cross-linked natural rubbers, a mixture of at least one polyol and at least one isocyanate, or cationically or anionically polymerizable monomers.

50. A method according to claim 2, characterized in that the polymeric source material includes a thermoplastic polymer and/or a thermoplastic elastomer.

51. A method according to claim 2, characterized in that the polymeric source material is selected from the group comprising polyolefins, ASA polymerizates, ABS polymerizates, polycarbonates, polyesters, polyamides, polyethers, polyimides, polyether ketones, polystyrenes, polyurethanes, polyphenylene sulfides, polyphenylene ethers, polyacrylates, polyacrylamides, polyacrylnitrile, polysulfones, polyvinyl chlorides, SAN polymerizates, epoxy resins, phenolic resins, each in impact-resistant modified and non-impact-resistant modified form, and mixtures thereof.

52. A method according to claim 2, characterized in that the polymeric source material contains duroplastic polymers and/or reactive elastomers and/or that the prepolymeric source material contains preliminary products of duroplastic polymers and/or reactive elastomers.

53. A method according to claim 2, characterized in that (1) phyllosilicates, in particular montmorillonite, smectite, ellite, sepiolite, palygorskite, muscovite, allivardite, amesite, hectorite, fluorohectorite, saponite, beidellite, talcum, nontronite, stevensite, bentonite, mica, vermiculite, fluorovenniculite, halloysite and synthetic talcum types containing fluorine and mixtures of the above, and/or (2) at least one silicon compound suitable for a sol-gel process, in particular pyrogenic silicic acid, and/or (3) soots produced on the basis of carbon, and/or (4) nano tubes or powders, are utilized as nanoparticle preliminary material and/or as nanoparticles.

54. A method according to claim 2, characterized in that an average length and/or width of the nanoparticles employed lies in a range from 20 to 500 nm and/or an average thickness and/or radius of these nanoparticles lies in a range from 1 to 250 nm.

55. A method according to claim 2, characterized in that the chemical propellant is selected from the group comprising azo and diazo compounds, in particular azodicarboxylic acid diamide, sulfohydrazides, semicarbazides, citric acid and its esters, peroxo, triazine, tetrazole, tetrazone or tetramine compounds, and alkali or alkaline earth carbonates, in particular bicarbonate compounds.

56. A method according to claim 2, characterized in that the physical propellant is selected from the group comprising water, methanol, ethanol, dimethyl ether, methane, ethane, n- or i-propane, n-butane, n- or i-pentane, cyclopentane, hexanes, heptanes, heptenes, benzenes, chlorofluorocarbons, carbon dioxide or nitrogen.

57. A method according to claim 56, characterized in that water, carbon dioxide and nitrogen in supercritical condition are utilized.

58. A method according to claim 2, characterized in that when using thermoplastic source materials, at least an area of a molding die, or at least an area of the inside of the molding die, at least during part of a process of filling the die with the polymeric molten material and/or at least during part of a cooling process of the molten material that forms the molded part, is at a temperature that is above room temperature, in particular above the softening temperature of the molten material that fonrs the molded part.

59. A method according to claim 2, characterized in that for the production of profiles or molded parts from partially crystallized solidifying thermoplastics, at least part of at least the surface of the molding die is at a temperature that lies approximately 5° C. to 20° C. below the softening temperature or the crystallization temperature of the molten material that forms the molded part or profile.

60. A method according to claim 2, characterized in that for the production of profiles or molded parts from amorphously solidifying the molten material, at least part of at least the surface of the molding die is at a temperature that lies approximately 5° C. to 30° C. above the softening temperature of the molten material that forms the molded part or profile.

61. A method according to claim 2, characterized in that at least part of the molding die is a poor conductor of heat, includes in particular steel, high-alloy steels and/or titanium, and is provided with a ceramic and/or plastic coating.

62. A method according to claim 2, characterized in that before the molding die is filled with the polymeric molten material, a layer of film is placed on at least part of the surface of the molding die.

63. A method according to claim 2, characterized in that the plasticizing unit is a component of a die casting device, a press system or an extruder, or is a die casting tool, a press system or an extruder.

64. A method according to claim 63, characterized in that the molding die or the press system is filled with gas under elevated pressure before being filled with the polymeric molten material.

65. A molded part obtainable according to the method of claim 2.

66. A profile obtainable according to the method of claim 2.

67. A granulate obtainable according to the method of claim 2.

68. A granulate according to claim 67, characterized in that the granulate is present in non-foanmed and/or pre-foamed form.
